(19) United States
(12) Patent Application Publication
(10) Pub. No.: US 2021/0253363 A1
(43) Pub. Date: Aug. 19, 2021

(54) SYSTEM FOR CONTINUOUSLY LOADING UTILITY VEHICLES

(71) Applicants: THYSSENKRUPP INDUSTRIAL SOLUTIONS AG, Essen (DE); Thyssenkrupp AG, Essen (DE)

(72) Inventor: Daniele NARO, Gelsenkirchen (DE)

(73) Assignees: THYSSENKRUPP INDUSTRIAL SOLUTIONS AG, Essen (DE); thyssenkrupp AG, Essen (DE)

(21) Appl. No.: 17/265,197

(22) PCT Filed: Jul. 25, 2019
(86) PCT No.: PCT/EP2019/070091

§ 371 Date: Feb. 1, 2021

(30) Foreign Application Priority Data
Aug. 6, 2018 (DE) 10 2018 213 079.5

(51) Int. Cl. B65G 43/10; B65G 67/04; G05B 15/02; G08G 1/07

(52) U.S. Cl. CPC B65G 43/10; B65G 67/04; B65G 2814/0344; G08G 1/07; G05B 15/02

(57) ABSTRACT

A system for continuously loading utility vehicles with material may include a multiple chute that is switchable into different states to load different utility vehicles successively with material, at least two utility vehicles arranged in a front row and at least one utility vehicle in at least one subsequent row, wherein at least one utility vehicle in the front row is followed, counter to its direction of travel, by the utility vehicle unfilled in the subsequent row, a drive-through control system with each utility vehicle being assigned a drive-through control element, a presence sensor system with each utility vehicle being assigned a presence sensor, a material filling level-sensing system, wherein each utility vehicle in the front row is assigned a material filling level-sensing sensor, and a computer system for controlling the state of the multiple chute based on data from the presence sensor system and the material filling level-sensing system.

### TECHNICAL FIELD

The present invention relates to a system for continuously loading utility vehicles with material as claimed in claim 1. Furthermore, the invention relates to a method for loading utility vehicles of the abovementioned system.

### BACKGROUND

It is generally known that utility vehicles are loaded with material. However, completely continuous loading of the utility vehicles by means of a multiple chute is not known.

### DESCRIPTION OF THE INVENTION

The object of the present invention is therefore to provide a system and a method of the abovementioned type, wherein the efficiency of loading utility vehicles is to be improved by means of the multiple chute.

In order to achieve this object, the invention provides, in particular, a system for continuously loading utility vehicles with material, having at least one multiple chute which can be switched into different switch states in order to load different utility vehicles successively with material, wherein the multiple chute is, in particular, a breeches chute. A breeches chute serves to branch off the stream of material by means of gravity. Furthermore, the system comprises at least three utility vehicles. In order to ensure continuous loading, more than three utility vehicles are preferred. This applies, in particular if the utility vehicles or the loading and unloading points are hundreds or thousands of meters apart from one another. Therefore, continuous loading can still be ensured. The utility vehicles are arranged in at least two rows, specifically at least two vehicles in a front row and at least one utility vehicle in at least one subsequent row, wherein at least one utility vehicle in the front row is followed, counter to its direction of travel, by the at least one utility vehicle unfilled in the at least one subsequent row. Likewise, the system comprises a drive-through control system, wherein each utility vehicle is assigned a drive-through control element. Furthermore, the system comprises a presence sensor system, wherein each utility vehicle is assigned a presence sensor. A material filling level-sensing system is also provided, wherein each utility vehicle in the front row is assigned a material filling level-sensing sensor. The system also significantly comprises a computer system in order to control the switch state of the multiple chute on the basis of the data from the presence sensor system and of the material filling level-sensing system.

The numerical formulation of the utility vehicles, specifically in particular first, second and third utility vehicles, is not to be understood as limiting but rather as facilitating the understanding of the drawings. As soon as the process repeats, the numerical sequence is invalid. The utility vehicles may be, in particular, identical in design so that this formulation is used with ascending numbering only in order to describe the invention more clearly. The utility vehicle which was originally the first one can receive different numbering when it drives in again. When the utility vehicles are identified unambiguously, vehicles which are not of identical design are also conceivable. They can then be known to the computer system before the respective loading. The individual utility vehicle data items can then be stored in the computer system.

The abovementioned subsystems of the overall system, specifically the presence sensor system and the material filling level-sensing system, are suitable for acquiring data which is evaluated by the computer system, and therefore permitting the most advantageous control possible of the drive-through control system and therefore of the utility vehicles which are to be filled, so that they can be loaded continuously.

There is particularly preferably provision that only the utility vehicles of the front row are to be loaded with material by the multiple chute. In particular if the front row and the at least one subsequent row are far apart from one another, this permits a simple configuration of the multiple chute.

In this context, the multiple chute is, in particular, a double chute, a triple chute or a quadruple chute. With each increase in the chute outlet the necessary time for the utility vehicles to move up into a position in the front row which has become empty is extended. For this purpose, the front row can advantageously also be equipped with a corresponding number of utility vehicles corresponding to the number of chute outlets. A triple chute already means that the time for moving up a new utility vehicle into the front row is doubled. This consequently means that a utility vehicle is filled, a second utility vehicle is parked and can be filled next, and a third utility vehicle moves up, wherein said vehicle can wait for the loading of the first and second utility vehicles. This is particularly advantageous in order to ensure continuous loading as far as possible.

The drive-through control system can be, in particular, a traffic light system. This is a particularly simple drive-through control possibility. Alternatively it may also be advantageous for the drive-through control to be carried out in each case by means of an operator control unit in a utility vehicle.

It is particularly advantageous that the system has a front row and two subsequent rows with utility vehicles so that there is an increased number of utility vehicles which can be moved up. In particular in the event of a breakdown of a utility vehicle, the utility vehicles can be more easily replaced in this context.

Furthermore, a preferred embodiment provides that the system has at least two, preferably three, utility vehicles for the front row and/or per subsequent row. Therefore, in particular in the case of a three-way chute, it is advantageous if three utility vehicles are used.

The control by means of the computer system can be optimized further for the purpose of achieving the object if a measuring system which measures the quantity of the conveyed material and passes on the measured data to the computer system is arranged upstream of the multiple chute. In this way it can be better predicted when at the latest a utility vehicle has to be driven off or has to have arrived in order to ensure continuous loading as far as possible.

In this case, the system can couple to an arrangement for the continuous acquisition of material. In other words, it has become apparent that the system according to the invention can also be implemented particularly advantageously in conjunction with mobile mining equipment or conveying technology arrangements whose stream of material is not fed from stationary bins but rather from a continuous acquisition, conveying and crushing process.

The system can make available at least one interface between, on the one hand, an arrangement for the continuous acquisition of material and, on the other hand, a discontinuous material removal means, in that the continuous stream of material is discretized into discontinuous material batches. In other words, the invention is based here on a concept of ensuring an interface which is as efficient as possible between, on the one hand, a continuous stream of material (acquisition) and, on the other hand, the discontinuous transport of material with trucks.

Furthermore, the invention relates to a method for loading utility vehicles with a system as per at least one of the abovementioned features, wherein the method is characterized by the following method steps:
before and/or during the loading of the first utility vehicle, the filling level of the at least second utility vehicle in the front row is measured by means of its material filling level-sensing sensor,
loading a single utility vehicle, specifically the first one, with material by means of the multiple chute, wherein the filling level of the utility vehicle is measured by means of its material filling level-sensing sensor,
if the second utility vehicle contains a defined filling quantity, a release signal is issued for the second utility vehicle by the drive-through control element assigned to it, so that the second utility vehicle moves away from its current position,
the third utility vehicle which follows the second utility vehicle counter to its direction of travel and in the subsequent row receives, from the drive-through control element assigned to it, a release signal so that the third utility vehicle moves from its current position into the previous position of the second utility vehicle,
a utility vehicle moves up into the previous position of the third utility vehicle in the subsequent row,
wherein the multiple chute switches over to the third utility vehicle along the front row for the purpose of loading, as soon as the material filling level-sensing sensor of the first utility vehicle contains a defined filling quantity,

wherein the presence sensor system checks continually whether there is a utility vehicle in the subsequent row, so that a further utility vehicle can move up subsequent to a utility vehicle which moves away out of the front row. By acknowledging these essential method steps it is possible to ensure that as far as possible continuous loading of utility vehicles takes place.

Reduced fault influences, in particular due to human operator control errors, can result in a higher probability of utility vehicles being loaded continuously by means of an automated system if the utility vehicles travel unmanned.

In this context, according to one preferred measure, the efficiency of the method can be optimized further if the switching of the multiple chute is carried out by the computer system without a waiting time.

In order to avoid damage of utility vehicles there is preferably provision that the multiple chute is switched into a closed operating state by the computer system insofar as before or during the loading of a utility vehicle, the presence sensor assigned to said vehicle detects that the utility vehicle is not correctly located in its loading position, or insofar as the completely filled utility vehicle contains the defined filling quantity and no further utility vehicle 2 of the front row 41 is unfilled. ‘Filled’ means, in contrast with the designation ‘unfilled’, in particular that the respective utility vehicle no longer has any intake capacity. Finally, a breakdown of a utility vehicle, possibly because of spilt material would lead to an interruption in the loading of material, which would result in subsequent costs.

According to one advantageous measure of the method, after the loading of a utility vehicle the multiple chute switches over to another utility vehicle only when the presence sensor of the at least one other utility vehicle of the front row has detected its presence and its correct position for loading. This prevents material from dropping onto the underlying surface, as a result of which the subsequent loading of a utility vehicle could possibly be considerably delayed.

The invention is already advantageous in the first implementation of the method. The individual steps are, however, particularly advantageously repeated continuously in succession.

The material can be picked up and fed in batches to the respective utility vehicle during the loading of an arrangement for the continuous acquisition of material. In other words, the method can buffer between continuous and discontinuous handling of material. During the loading of the utility vehicle, the continuous stream of material can be discretized into discontinuous batches of material between, on the one hand, an arrangement for the continuous acquisition of material and, on the other hand, a discontinuous material removal means.

Likewise, the invention relates to an operator control unit for a utility vehicle for carrying out the method according to one of the preceding features, wherein the operator control unit communicates without cables with the computer system. In this way a flexible use of the utility vehicle can be ensured.

It is also preferred that the operator control unit is embodied as a retrofitted unit.

### DESCRIPTION OF THE FIGURES

FIG. 1 shows a schematic plan view of a system for continuously loading utility vehicles as an exemplary embodiment of the invention,

FIG. 2 shows a system according to FIG. 1 in a subsequent method step,

FIG. 3 shows a system according to FIG. 2 in a subsequent method step,

FIG. 4 shows a system according to FIG. 3 in a subsequent method step,

FIG. 5 shows a system according to FIG. 4 in a subsequent method step, and

FIG. 6 shows a system according to FIG. 5 in a subsequent method step.

### DETAILED DESCRIPTION OF THE FIGURES

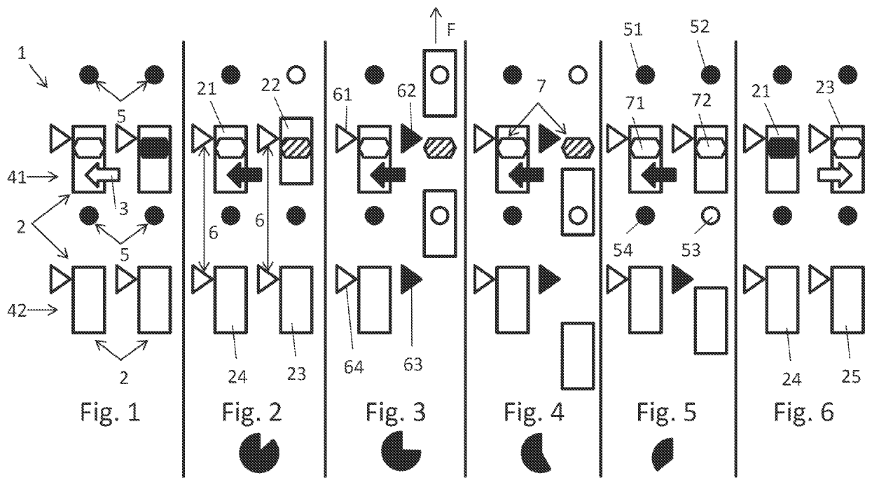

FIGS. 1 to 6 illustrate respective schematic plan views of a preferably embodied system 1 for the continuous loading of utility vehicles 2 in different method steps as an exemplary embodiment. In this context, for the sake of clarity the reference symbols have been represented distributed over the six figures, but they respectively apply to each figure. All the components of the system are illustrated schematically.

Overall, the preferably embodied system 1 comprises at least one multiple chute 3 which can be switched into different switch states. The multiple chute 3 is provided to load different utility vehicles 2 successively with material, wherein the multiple chute is, in particular, a breeches chute.

The illustrated system comprises four utility vehicles 21, 22, 23, 24, wherein these utility vehicles 21, 22, 23, 24 are arranged in two rows 41, 42, specifically according to FIG. 1 two utility vehicles 21, 22 in a front row 41 and two utility vehicles 23, 24 in a subsequent row 42. The utility vehicles 23, 24 of the subsequent row 42 follow unfilled the utility vehicles 21, 22 of the front row 41, counter to their direction of travel F. ‘Unfilled’ means the utility vehicles 23, 24 have intake capacities for loading with material by means of the multiple chute 3. In this way, the utility vehicles 21, 22, 23, 24 are positioned with a different formulation in a two times two arrangement, wherein the utility vehicles 23, 24 of the subsequent row 42 are empty with respect to material.

The numerical formulation of the utility vehicles, specifically in particular first, second and third utility vehicles, is not to be understood as limiting but rather is intended to facilitate understanding of the figures. As soon as the process repeats, the numerical sequence is basically invalid. The utility vehicles are of identical design so that this formulation with ascending numbering is used only to describe the invention more clearly, in particular in the figures.

By virtue of this configuration of the two utility vehicles 21, 22 of the front row 41, the multiple chute 3 is embodied as a double chute. In this context, only the utility vehicles 21, 22 of the front row 41 are to be coated with material by means of the double chute 3.

Furthermore, the system 1 has a drive-through control system 5. In this context, each utility vehicle 21, 22, 23, 24 is assigned a drive-through control element 51, 52, 53, 54. The drive-through control system 5 can preferably be a traffic light system, wherein each drive-through control element 51, 52, 53, 54 is, in particular, a separate traffic light system. However, the signal for drive-through control can, for example, also be carried out within the vehicle by means of an operator control unit.

Likewise, the system comprises a presence sensor system 6, wherein each utility vehicle 21, 22, 23, 24 is assigned a presence sensor 61, 62, 63, 64. The presence sensor system 6 serves to sense whether and where the respective utility vehicles 2 are available for loading with material.

A material filling level-sensing system 7 is also illustrated schematically as a component of the system 1, wherein each utility vehicle 21, 22 of the front row 41 is assigned a material filling level-sensing sensor 71, 72. Therefore, the multiple chute 3 can be switched to an unfilled utility vehicle 21 as soon as the utility vehicle 22 is filled, see FIGS. 1 and 2.

The multiple chute is controlled by means of a computer system (not illustrated). The switch state of the multiple chute 3 is preferably controlled on the basis of the data from the presence sensor system 6 and of the material filling level-sensing system 7. In particular there is provision that a measuring system (not illustrated) which measures the quantity of the conveyed material and passes on the measured data to the computer system is arranged upstream of the multiple chute 3. The loading speed or the loading quantity of the utility vehicle 2 to be loaded can then be very largely predicted.

FIG. 1 shows, by means of the material filling level-sensing sensor 71, which is illustrated in an empty state, that the first utility vehicle 71 is unfilled. The multiple chute 3 is switched to the first utility vehicle, but there is no flow of material. This is apparent from the schematically empty arrow. The second utility vehicle 22 is filled with material. This is apparent from the fact that its material filling level-sensing sensor 72 is illustrated filled. All four utility vehicles 21, 22, 23, 24 have a signal to stop. This is apparent from the drive-through control elements 51, 52, 53, 54, illustrated in the filled state, of the drive-through control system 5. All four utility vehicles 21, 22, 23, 24 are present and in their respective correct position. This is apparent from the presence sensors 61, 62, 63, 64, illustrated in an empty state, of the presence sensor system 6.

There is basically provision that before and/or during and/or after the loading of the first utility vehicle 21 the filling level of the second utility vehicle 22 in the front row 41 is measured by means of its material filling level-sensing sensor 72, see FIG. 1. This serves to ensure that the flow of material of the multiple chute 3 after the filling of the first utility vehicle 21 is not switched to a utility vehicle 21 which is already filled. According to FIG. 1, the second utility vehicle 22 has been detected as filled by its material filling level-sensing sensor 72. The second utility vehicle 22 which is detected as filled according to FIG. 1 receives the release signal to drive off from the drive-through control system 52 which is assigned to said second utility vehicle 22. After this, the material filling level-sensing sensor 72 of the originally second utility vehicle 22 switches into a ready-to measure state. This is illustrated schematically with the hatched content of the material filling level-sensing sensor 72, see FIG. 2.

According to the illustration in FIG. 2, at the same time as the driving away of the filled second utility vehicle 22, the first utility vehicle 21 is loaded with material by the multiple chute 3, wherein the filling level of the first utility vehicle 21 is measured by means of its material filling level-sensing sensor 71. The fact that the first utility vehicle 21 is not yet completely filled is apparent from the material filling level-sensing sensor 71 which is illustrated in the empty state.

In order to ensure that the multiple chute 3 can switch over to another utility vehicle 2 without a waiting time as soon as the first utility vehicle 21 is filled, during the filling process the filled second utility vehicle 22 is simultaneously replaced with an unfilled, third utility vehicle 23. This takes place during the method steps in FIGS. 2 to 5 and is illustrated schematically by means of the running clock.

The third utility vehicle 23 which follows the second utility vehicle 22, counter to its direction of travel F and in the subsequent row 42, receives according to FIG. 3, by means of the drive-through control element 53 assigned to it, a release signal so that the third utility vehicle 23 drives from its current position into the previous position of the second utility vehicle 22 as soon as there is enough space for the third utility vehicle 23, as a result of the second utility vehicle 22 driving away.

The presence sensors 62, 63 of the second and third utility vehicles 22, 23 detect that there is no utility vehicle arranged at the position provided.

While the third utility vehicle 23 assumes the previous position of the second utility vehicle in the front row 41, according to FIGS. 4 to 6 a utility vehicle 25 moves on into the previous position of the third utility vehicle 23 in the subsequent row 42.

In FIG. 5 is it apparent that the material filling level-sensing sensor 72 detects the unfilled state of the utility vehicle 2. The position sensor 62 detects the utility vehicle 2 is already ready in the front row 41, while the position sensor 63 detects that there is still no utility vehicle 2 ready in the subsequent row 42.

According to FIG. 6, the multiple chute 3 switches along the front row 41 for loading onto the third utility vehicle 23 as soon as the material filling level-sensing sensor 71 of the first utility vehicle 21 contains a defined filling quantity.

FIG. 6 then shows a similar output position for the next method step as in FIG. 1 for FIG. 2. In other words, the method steps of FIGS. 2 to 5 can be repeated, wherein the loading takes place merely in a mirror-symmetrical fashion.

### LIST OF REFERENCE SYMBOLS

1 System for continuously loading utility vehicles
2 Utility vehicle
21 First utility vehicle
22 Second utility vehicle
23 Third utility vehicle
24 Fourth utility vehicle
3 Multiple chute
41 Front row
42 Subsequent row
5 Drive-through control system
51 Drive-through control element of the first utility vehicle
52 Drive-through control element of the second utility vehicle
53 Drive-through control element of the third utility vehicle
54 Drive-through control element of the fourth utility vehicle
6 Presence sensor system
61 Presence sensor of the first utility vehicle
62 Presence sensor of the second utility vehicle
63 Presence sensor of the third utility vehicle
64 Presence sensor of the fourth utility vehicle
7 Material filling level-sensing system
71 Material filling level-sensing sensor of the first utility vehicle
72 Material filling level-sensing sensor of the second utility vehicle
F Direction of travel of the utility vehicle

1-19. (canceled)

20. A system for continuously loading utility vehicles with material, the system comprising:
a multiple chute configured to switch into different states to load different utility vehicles successively with material;
a first utility vehicle, a second utility vehicle, and a third utility vehicle, with the first and second utility vehicles being arranged in a front row and the third utility vehicle being arranged in a subsequent row, wherein at least one of the first utility vehicle or the second utility vehicle in the front row is followed counter to its direction of travel by the third utility vehicle unfilled in the subsequent row;
a drive-through control system, wherein each of the first, second, and third utility vehicles is assigned a drive-through control element;
a presence sensor system, wherein each of the first, second, and third utility vehicles is assigned a presence sensor;
a material filling level-sensing system, wherein each of the first, second, and third utility vehicles is assigned a material filling level-sensing sensor; and
a computer system for controlling the switch status of the multiple chute based on data from the presence sensor system and from the material filling level-sensing system.

21. The system of claim 20 wherein only the first and second utility vehicles in the front row are to be loaded with material by the multiple chute.

22. The system of claim 20 wherein the multiple chute is a double chute, a triple chute, or a quadruple chute.

23. The system of claim 20 wherein the drive-through control system is a traffic light system.

24. The system of claim 20 wherein the subsequent row is a first subsequent row, wherein the system comprises a second subsequent row with another utility vehicle.

25. The system of claim 20 comprising a fourth utility vehicle arranged in the subsequent row.

26. The system of claim 20 comprising a measuring system configured to measure a quantity of material conveyed to the utility vehicles as measured data and transmit the measured data to the computer system disposed upstream of the multiple chute.

27. The system of claim 20 configured to couple to an arrangement for continuous acquisition of material.

28. The system of claim 20 configured for interfacing between an arrangement for continuous acquisition of material and a discontinuous material removal means where a continuous stream of material is discretized into discontinuous batches of material.

29. A method for loading utility vehicles with the system of claim 20, the method comprising:
before and/or during loading of the first utility vehicle, measuring a filling level of the second utility vehicle in the front row by way of the material filling level-sensing sensor of the second utility vehicle;
loading the first utility vehicle by way of the multiple chute, wherein a filling level of the first utility vehicle is measured by way of the material filling level-sensing sensor of the first utility vehicle;
once the second utility vehicle contains a defined filling quantity, issuing a release signal for the second utility vehicle by the drive-through control element assigned to the second utility vehicle so that the second utility vehicle moves away from its current position;
receiving a release signal at the third utility vehicle from the drive-through control element assigned to the third utility vehicle so that the third utility vehicle moves from its current position to a previous position of the second utility vehicle;
moving a fourth utility vehicle up into a previous position of the third utility vehicle in the subsequent row;
switching the multiple chute over to the third utility vehicle along the front row for loading as soon as the material filling level-sensing sensor of the first utility vehicle contains a defined filling quantity; and
continually checking with the presence sensor system whether there is a utility vehicle in the subsequent row in order to move up a further utility vehicle subsequent to a utility vehicle that moves away out of the front row.

30. The method of claim 29 wherein the utility vehicles travel unmanned.

31. The method of claim 29 comprising switching the multiple chute with the computer system without a waiting time.

32. The method of claim 29 comprising switching the multiple chute into a closed operating state by the computer system before or while loading one of the utility vehicles upon the presence sensor assigned to the respective utility vehicle detecting that the respective utility vehicle is not located in a correct loading position or upon the completely filled respective utility vehicle containing a defined filling quantity and no other utility vehicle in the front row being unfilled.

33. The method of claim 29 comprising, after loading a utility vehicle, switching the multiple chute to another utility vehicle only when the presence sensor of another utility vehicle in the front row has detected its presence and its correct position for loading.

34. The method of claim 29 comprising repeating individual steps.

35. The method of claim 29 wherein during loading of an arrangement for the continuous acquisition of material, the method comprises picking up and feeding material in batches to a respective utility vehicle.

36. The method of claim 29 wherein during loading of the utility vehicles between an arrangement for continuous acquisition of material and a discontinuous material removal means, the method comprises discretizing a continuous stream of material into discontinuous batches of material.

37. An operator control unit for a utility vehicle for performing the method of claim 29, wherein the operator control unit communicates without cables with the computer system.

38. The operator control unit of claim 37 configured as a retrofitted unit.
